(19) United States
(12) Patent Application Publication
(10) Pub. No.: US 2026/0192543 A1
(43) Pub. Date: Jul. 9, 2026

(54) FIBER REINFORCED PLASTIC MEMBER FOR VEHICLE BODY

(71) Applicant: Nissan Motor Co., Ltd., Yokohama-shi, Kanagawa (JP)

(72) Inventors: Akihisa OTSUKI, Kanagawa (JP); Kazuya OKAZAKI, Kanagawa (JP)

(21) Appl. No.: 19/131,546

(22) PCT Filed: Nov. 25, 2022
(86) PCT No.: PCT/JP2022/043627

§ 371 Date: May 21, 2025

(51) Int. Cl. B32B 5/26; B32B 27/08; B32B 27/12; B32B 27/20

(52) U.S. Cl. CPC B32B 5/26; B32B 27/08; B32B 27/12; B32B 27/20; B32B 2260/046; B32B 2262/106; B32B 2307/7376; B32B 2605/00

(57) ABSTRACT

A fiber reinforced plastic member for a vehicle body includes: a plurality of first reinforced fiber layers, a plurality of second reinforced fiber layers and a matrix resin. The first reinforced fiber layers includes reinforced fiber bundles which are not spread. The second reinforced fiber layers includes reinforced fiber bundles which are spread and continuously stacked. The matrix resin is impregnated into the first and second reinforced fiber layers. When a load is generated in an in-plane direction by an external force bending the fiber reinforced plastic member a tensile force acts on the fiber reinforced plastic member a region of a bending outer side is defined as a tensile side region on which a tensile stress acts with respect to a center plane having a thickness of the fiber reinforced plastic member. The second reinforced fiber layers are arranged in the tensile side region.

### CROSS-REFERENCE TO RELATED APPLICATIONS

This application is a U.S. national stage application of International Application No. PCT/JP2022/043627, filed on Nov. 25, 2022.

### BACKGROUND

### Technical Field

The present invention relates to a fiber reinforced plastic member for a vehicle body.

### Background Information

Japanese Patent Application Publication No. 2014-208457 (hereinafter referred to as Patent Literature 1) discloses a carbon fiber reinforced plastic member. In the carbon fiber reinforced plastic member disclosed in Patent Literature 1, a plurality of carbon fiber thin layers formed by tow spreading are stacked in the matrix resin. The fiber bundle of carbon fibers used for a carbon fiber reinforced plastic is composed of a large number of filaments and usually has a circular or an elliptical cross section. The fiber bundle is also called a tow, and carbon fiber filaments with a diameter of 4 to 7 μm are often used for a tow made of carbon fibers.

A tow is classified by the number of filaments, such as 12k and 24k. A tow of 12k includes 12000 filaments. Generally, a tow with relatively fine bundles of 24k or less is called a regular tow, and a tows with thick bundles of 40k or more is called a large tow. A tow spreading technology is a technology to spread filaments of a tow thinly and uniformly, and a large tow is usually used. When a plurality of carbon fiber thin layers formed using tows which are spread are stacked to form a carbon fiber reinforced plastic member, mechanical properties such as strength and an elastic modulus (hardness) of a carbon fiber reinforced plastic member can be improved, as disclosed in Patent Literature 1.

### SUMMARY

However, since each carbon fiber thin layer is reduced in thickness, the number of stacked layers of the carbon fiber thin layers in the carbon fiber reinforced plastic member increases. Therefore, there is a problem that it is difficult to improve productivity due to an increase in the number of steps of stacking layers.

An object of the present invention is to provide a fiber reinforced plastic member for a vehicle body that is capable of improving productivity while improving mechanical properties.

A fiber reinforced plastic member for a vehicle body according to a first feature of the present invention includes: a plurality of first reinforced fiber layers formed by reinforced fiber bundles which are not spread; a second reinforced fiber layer group in which a plurality of second reinforced fiber layers formed by reinforced fiber bundles which are spread are continuously stacked; and a matrix resin which is impregnated into the plurality of first reinforced fiber layers and the plurality of second reinforced fiber layers and is reinforced by the plurality of first reinforced fiber layers and the plurality of second reinforced fiber layers. When a load is generated in an in-plane direction by an external force bending the fiber reinforced plastic member and a compressive force or a tensile force acts on the fiber reinforced plastic member, a region of a bending inner side of the fiber reinforced plastic member is defined as a compressive side region on which a compressive stress acts and a region of a bending outer side of the fiber reinforced plastic member is defined as a tensile side region on which a tensile stress acts with respect to a center plane having a thickness of the fiber reinforced plastic member. The second reinforced fiber layer group is arranged in the tensile side region.

A fiber reinforced plastic member for a vehicle body according to a second feature of the present invention includes: a plurality of first reinforced fiber layers formed by reinforced fiber bundles which are not spread; a second reinforced fiber layer group in which a plurality of second reinforced fiber layers formed by reinforced fiber bundles which are spread are continuously stacked; and a matrix resin which is impregnated into the plurality of first reinforced fiber layers and the plurality of second reinforced fiber layers and is reinforced by the plurality of first reinforced fiber layers and the plurality of second reinforced fiber layers. When a load is generated in an in-plane direction by an external force bending the fiber reinforced plastic member and a compressive force or a tensile force acts on the fiber reinforced plastic member, a region of a bending inner side of the fiber reinforced plastic member is defined as a compressive side region on which a compressive stress acts and a region of a bending outer side of the fiber reinforced plastic member is defined as a tensile side region on which a tensile stress acts with respect to a center plane having a thickness of the fiber reinforced plastic member. The second reinforced fiber layer group is arranged in the compressive side region.

The above first feature makes it possible to improve the strength of a fiber reinforced plastic member by means of a second reinforced fiber layer group while improving the productivity of the fiber reinforced plastic member by reducing the number of stacked layers of second reinforced fiber layers that are thin layers.

The above second feature makes it possible to improve the hardness of a fiber reinforced plastic member by means of a second reinforced fiber layer group while improving the productivity of the fiber reinforced plastic member by reducing the number of stacked layers of second reinforced fiber layers that are thin layers.

### BRIEF DESCRIPTION OF DRAWINGS

Referring now to the attached drawings which form a part of this original disclosure, illustrative embodiments are shown.

FIG. 1 is a schematic perspective view for explaining tow spreading.

FIG. 2 is a partial cross-sectional view of a fiber reinforced plastic member for explaining a tension side region and a compressive side region.

FIG. 3 is a partial schematic cross-sectional view of the fiber reinforced plastic member according to a first embodiment.

FIG. 4 is a partial schematic cross-sectional view of the fiber reinforced plastic member according to a second embodiment.

FIG. 5 is a partial schematic cross-sectional view of the fiber reinforced plastic member according to a third embodiment.

### DETAILED DESCRIPTION OF EMBODIMENTS

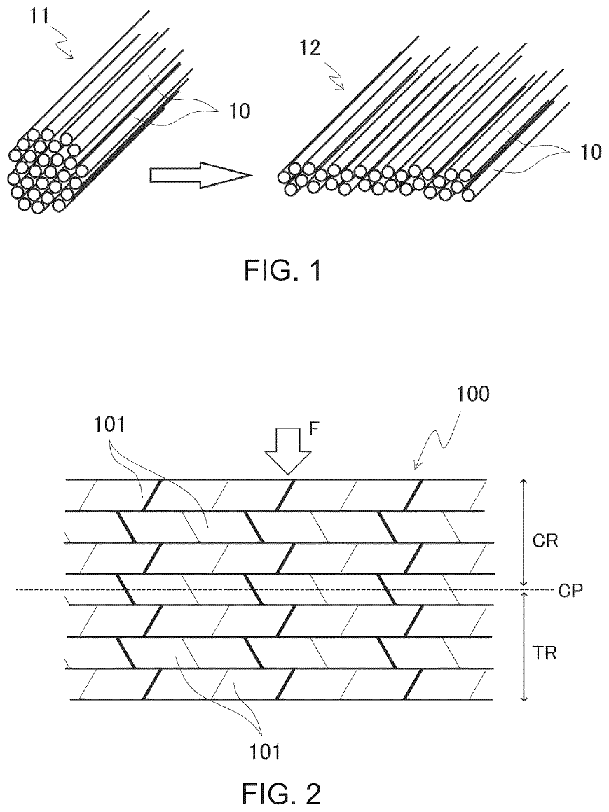

First, “tow spreading” will be described with reference to FIG. 1. Tow spreading is a technology related to reinforced fibers that are long fibers and is not used for reinforced fibers that are short fibers. The long fiber reinforced fibers which are not spread are a fiber bundle 11 in which many filaments 10 are bundled as illustrated on the left side of FIG. 1, that is, in the state of a tow 11. The tow 11 includes thousands to tens of thousands of filaments. FIG. 1 is a schematic diagram, and the number of filaments 10 is not accurate. The cross section of the tow 11 which is not spread is circular or elliptical. A technology to form a tow 12 illustrated on the right side of FIG. 1 by flatly spreading the tow 11 is a tow spreading technology, and there are various tow spreading methods. The tow 12 which is spread may be arranged in parallel to form a unidirectional (UD) reinforced fiber layer, or the tow 12 which is spread may be woven to form a quasi-isotropic reinforced fiber layer. Quasi-isotropy can also be realized by stacking a plurality of tows 12 while crossing directions of unidirectionality.

Note that it is possible to determine whether or not the reinforced fiber layer in the fiber reinforced plastic member after molding is formed by a fiber bundle (tow) which is spread by observing the thickness of the reinforced fiber layer and the distribution uniformity of filaments in the reinforced fiber layer.

The reinforced fiber layer formed by the tow 12 which is spread is reduced in thickness. Therefore, matrix resin can be sufficiently impregnated into the reinforced fiber layer. As a result, resin peeling in the reinforced fiber layer can be suppressed. Further, when the tow 11 having a circular cross section is arranged, gaps tend to be formed therein; however, by stacking the flat tow 12, a fiber volume content rate Vf [%] of the reinforced fiber can be improved. As a result, the mechanical properties of the fiber reinforced plastic can be improved. Therefore, the fiber reinforced plastic using the tow 12 which is spread exhibits improved mechanical properties. However, when the fiber reinforced plastic member is formed using only the tow 12 which is spread, a larger number of stacked layers is required than the reinforced fiber layer using the tow 11 which is not spread as described above.

There are various molding methods of fiber reinforced plastic members, such as a method using prepreg in which s thermosetting resin is used or an RTM method using a thermoplastic resin. In the method using prepreg, a large number of stacked layers is required when stacking thin prepreg made using the tow 12 which is spread onto a shaping mold. Even in the RTM method, a large number of stacked layers is required when stacking and setting the tow 12 which is spread into a mold. Therefore, a large amount of time is required for a stacking process, making it difficult to improve the productivity. In the following embodiments, the productivity is improved by optimizing the arrangement of the reinforced fiber layer using the tow 12 which is spread, while using both the reinforced fiber layer using the tow 12 which is spread and the reinforced fiber layer using the tow 11 which is not spread.

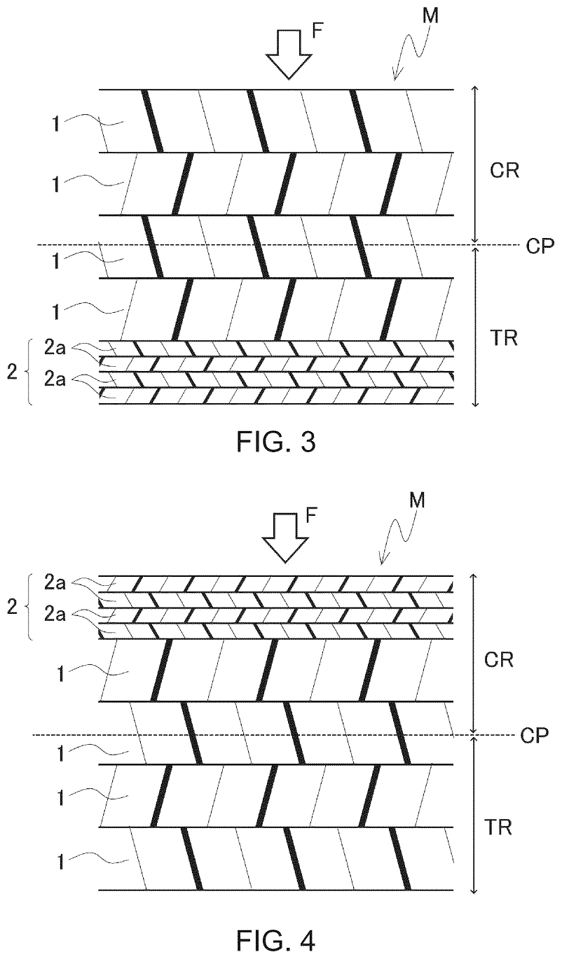

Next, the terms “tensile side region” and “compressive side region” will be described with reference to FIG. 2 before describing the embodiments. FIG. 2 illustrates a general fiber reinforced plastic member 100. A compressive force or a tensile force acts on the fiber reinforced plastic member 100 due to a load generated in the in-plane direction by an external force F bending the fiber reinforced plastic member 100. In the example illustrated in FIG. 2, the external force Facts in the thickness direction of the fiber reinforced plastic member 100, that is, in the stacking direction of the reinforced fiber layer 101. Similarly to FIG. 1, FIG. 2 schematically illustrates the cross section of the fiber reinforced plastic member 100. In FIG. 2, the reinforced fibers in the respective reinforced fiber layers 101 are not clearly illustrated, and FIG. 2 illustrates a state in which matrix resins are impregnated into the respective reinforced fiber layers 101. Further, the matrix resins in the respective reinforced fiber layers 101 are actually continuous with each other without forming a clear boundary. For example, when curing the matrix resin by heating after the prepreg impregnated with the matrix resin is stacked on the reinforced fiber layer, the matrix resin, which is a thermosetting resin, softens (liquefies) once, and then solidifies as the curing reaction proceeds. In this process, there is no clear boundary between the matrix resins of the prepreg, and thus the matrix resins are integrated. The schematic expressions illustrated in FIGS. 1 and 2 are the same in FIGS. 3 to 5, which will be described later.

As illustrated in FIG. 2, when a compressive force or a tensile force acts on the fiber reinforced plastic member 100 due to a load generated in the in-plane direction by the external force F bending the fiber reinforced plastic member 100, a compressive stress acts on the bending inner side inside the fiber reinforced plastic member 100 (bending concave side), and a tensile stress acts on the bending outer side (bending convex side). Here, with respect to the center plane CP having the thickness of the fiber reinforced plastic member 100, the region of the bending inner side of the fiber reinforced plastic member 100 is defined as a compressive side region CR on which a compressive stress acts. Similarly, the region of the bending outer side of the fiber reinforced plastic member 100 is defined as a tensile side region TR on which a tensile stress acts. Hereinafter, the first to third embodiments of the present invention will be described with reference to FIGS. 3 to 5, and the terms “tensile side region TR” and “compressive side region CR” are defined as described in this paragraph.

The fiber reinforced plastic member M according to the first to third embodiments illustrated in FIGS. 3 to 5, which will be described below, is used for a vehicle body. Examples of the fiber reinforced plastic member M for a vehicle body include a vehicle body structure member and a vehicle body panel member. The vehicle body structure member is a member that receives a collision load at the time of a vehicle collision. More specifically, examples of the vehicle body structure member include front and rear side members, side sills, A and B and C pillars, roof side rails, and the like. Further, more specifically, examples of the vehicle body panel member include bonnets/hoods covering an engine/motor room at the front of the vehicle body, trunk lids/hoods covering a trunk room at the rear of the vehicle body, front/rear fenders, door panels, and loop panels.

The vehicle body structure member is a member that receives a collision load at the time of a vehicle collision. When the fiber reinforced plastic member M is a side member, the side member buckles and absorbs a collision energy at the time of a front or rear collision. The buckling mode of the side member is controlled by the reinforcing member, and the beads formed on the side member. That is, depending on the position of the fiber reinforced plastic member M in the side member, it is known how the external force F that bends the fiber reinforced plastic member M acts on the fiber reinforced plastic member M at the time of a collision. Accordingly, the “tensile side region TR” and “compressive side region CR” of the fiber reinforced plastic member M when the external force F that bends the fiber reinforced plastic member M acts are known. When the fiber reinforced plastic member M is a side sill or B pillar, the side sill or B pillar secures a vehicle interior, that is, a survival space, at the time of a side collision. That is, when considering the external force F at the time of a side collision, it is known that the vehicle interior side of the fiber reinforced plastic member M becomes the “tensile side region TR”. When the fiber reinforced plastic member M is an A or a C pillar, or a roof rail, the A or C pillar, or the roof rail secures a vehicle interior, that is, a survival space, at the time of a vehicle rollover. That is, when considering the external force F at the time of a vehicle rollover, the vehicle interior side of the fiber reinforced plastic member M becomes the “tensile side region TR”.

The vehicle body panel member is a member mainly forming a vehicle body outer plate. When the fiber reinforced plastic member M is a vehicle body panel member, the external force F acts from the outer side of the vehicle. Luggage may be placed on a bonnet/hood, or a roof, or a person may lean against a fender or a door panel. Therefore, when the fiber reinforced plastic member M is a vehicle body panel member, it is known that the outer surface side of the vehicle body panel member where the external force F acts becomes the “compressive side region CR”. If the vehicle body panel member flexes easily, the quality of the vehicle body panel member is impaired.

As illustrated in FIG. 3, the fiber reinforced plastic member M of the first embodiment includes a plurality of first reinforced fiber layers 1, a second reinforced fiber layer group 2 in which a plurality of second reinforced fiber layers 2a are continuously stacked, and a matrix resin. Each of the first reinforced fiber layers 1 is formed of a reinforced fiber bundle (tow) which is not spread. Each of the second reinforced fiber layers 2a is formed of a reinforced fiber bundle (tow) which is spread. The matrix resin is impregnated into the first reinforced fiber layers 1 and the second reinforced fiber layers 2a, and is reinforced by the first reinforced fiber layers 1 and the second reinforced fiber layers 2a.

Each of the first reinforced fiber layer 1 and the second reinforced fiber layer 2a may have a unidirectionality in which a tow is arranged in parallel, or may be woven to have a quasi-isotropic unidirectionality. Further, since these fiber layers are stacked, quasi-isotropy can be realized by crossing the directionality of each layer. The reinforced fiber of the present embodiment is a carbon fiber. The second reinforced fiber layer group 2 is formed by continuously stacking the second reinforced fiber layers 2a formed by the tows which are spread. Therefore, as described above, the second reinforced fiber layer group 2 has good mechanical properties.

The second reinforced fiber layer group 2 is arranged in the tensile side region TR. A carbon fiber reinforced plastic (CFRP) reinforced by reinforced fibers, especially, carbon fibers used in the present embodiment, can effectively resist a tensile force. Accordingly, by arranging the second reinforced fiber layer group 2 in the tensile side region TR, the bending strength of the fiber reinforced plastic member M can be improved. For example, the fiber reinforced plastic member M of the present embodiment can be used as a vehicle body structure member because the strength is required for the vehicle body structure member described above.

Although it is possible to form the fiber reinforced plastic member M using only a large number of second reinforced fiber layers 2a, the number of stacked layers increases, making it difficult to improve the productivity as described above. As in the present embodiment, by using the second reinforced fiber layer group 2 only in a portion and the first reinforced fiber layers 1 in the remaining portions, the strength of the fiber reinforced plastic member M can be improved by the second reinforced fiber layer group 2 while improving the productivity by minimizing an increase in the number of stacked layers. In addition, since the second reinforced fiber layer group 2 having a high fiber volume content rate Vf of carbon fibers is used only in a portion, an increase in the amount of expensive carbon fibers to be used can be minimized, making it possible to suppress an increase in the manufacturing cost of the fiber reinforced plastic member M.

In particular, in the present embodiment, the second reinforced fiber layer group 2 is used as the outermost layer in the tensile side region TR of the fiber reinforced plastic member M. Therefore, the strength of the fiber reinforced plastic member M can be improved most effectively by the second reinforced fiber layer group 2. Even if it is not used as the outermost layer, the strength of the fiber reinforced plastic member M is improved as long as the second reinforced fiber layer group 2 is arranged in the tensile side region TR. However, the bending strength of the fiber reinforced plastic member M can be improved most effectively by arranging the second reinforced fiber layer group 2 in the outermost layer where the tensile stress in the fiber reinforced plastic member M generated by the external force F is the largest.

It has also been found out that the bending strength of the fiber reinforced plastic member M is improved when the second reinforced fiber layer group 2 is used only in the outermost layer of the tensile side region TR as in the present embodiment, rather than when the fiber reinforced plastic member M is formed only using a large number of second reinforced fiber layers 2a. This is because if the fiber reinforced plastic member M is formed only using a large number of second reinforced fiber layers 2a, layer separation tends to occur in the second reinforced fiber layer 2a of the compressive side region CR due to compression fracture. When considering only the strength, in a case where the second reinforced fiber layer group 2 is arranged in the tensile side region TR, the strength of the fiber reinforced plastic member M can be improved when only the first reinforced fiber layer 1 is arranged in the compressive side region CR.

It has also been found that, as in the present embodiment, when a single second reinforced fiber layer group 2 is arranged in the tensile side region TR and the remaining reinforced fiber layers are used as the first reinforced fiber layers 1, there is less variation in the strength of the fiber reinforced plastic member M. Specifically, a CV (coefficient of variation) value of the strength of the fiber reinforced plastic member M can be kept low. When considering only the strength, in a case where the second reinforced fiber layer group 2 is arranged in the tensile side region TR, a variation in the strength of the fiber reinforced plastic member M can be suppressed when the first reinforced fiber layer 1 is arranged in the compressive side region CR.

In the present embodiment, only a single second reinforced fiber layer group 2 is arranged in the tensile side region TR. Although a single second reinforced fiber layer group 2 is preferable to suppress the number of stacked layers, this does not prevent two or more second reinforced fiber layer groups 2 from being arranged in the tensile side region TR. For example, the following structure may be used: The second reinforced fiber layer group 2 that is a first group is arranged in the outermost layer of the tensile side region TR, and the first reinforced fiber layer 1 is arranged in the adjacent inner side thereof. The second reinforced fiber layer group 2 that is a second group is then arranged in the inner side of this first reinforced fiber layer 1. The first reinforced fiber layers 1 are then arranged in the inner side of the second reinforced fiber layer group 2 that is a second group and in the remaining reinforced fiber layers of the compressive side region CR.

FIG. 4 illustrates a fiber reinforced plastic member M of the second embodiment. In the present embodiment, the second reinforced fiber layer group 2 is arranged in the compressive side region CR. Each of the first reinforced fiber layers 1 of the present embodiment has the same structure as that of the first reinforced fiber layer 1 of the first embodiment. Each of the second reinforced fiber layers 2a of the present embodiment also has the same structure as that of the second reinforced fiber layer 2a of the first embodiment. The second reinforced fiber layer group 2 of the present embodiment also has the same structure as that of the second reinforced fiber layer group 2 of the first embodiment. Therefore, a duplicate description of these will be omitted.

By arranging the second reinforced fiber layer group 2 in the compressive side region CR, an elastic modulus, that is, the hardness, of the fiber reinforced plastic member M can be improved. For example, by using the fiber reinforced plastic member M of the present embodiment for the vehicle body panel member described above, the deflection of the vehicle body panel member can be effectively suppressed. In addition, the fiber reinforced plastic member M of the present embodiment has a higher strength than the bending strength of the fiber reinforced plastic member formed using only a plurality of first reinforced fiber layers 1 (however, the strength is lower than that of the fiber reinforced plastic member M of the first embodiment). It has been found out that in order to improve an elastic modulus (hardness) of the fiber reinforced plastic member M, it is more effective to arrange the second reinforced fiber layer group 2 only in the compressive side region CR than to arrange the second reinforced fiber layer group 2 only in the tensile side region TR.

As described above, when the fiber reinforced plastic member M is formed using a large number of second reinforced fiber layers 2a, the number of stacked layers increases, making it difficult to improve the productivity. As in the present embodiment, by using the second reinforced fiber layer group 2 only in a portion and the first reinforced fiber layers 1 in the remaining portions, an elastic modulus (hardness) of the fiber reinforced plastic member M can be improved by the second reinforced fiber layer group 2 while improving the productivity by minimizing an increase in the number of stacked layers. In addition, since the second reinforced fiber layer group 2 having a high fiber volume content rate Vf of carbon fibers is used only in a portion, an increase in the amount of expensive carbon fibers to be used can be minimized, making it possible to suppress an increase in the manufacturing cost of the fiber reinforced plastic member M.

In particular, in the present embodiment, the second reinforced fiber layer group 2 is used as the outermost layer in the compressive side region CR of the fiber reinforced plastic member M. Therefore, an elastic modulus (hardness) of the fiber reinforced plastic member M can be improved most effectively by the second reinforced fiber layer group 2. Even if it is not used as the outermost layer, an elastic modulus (hardness) of the fiber reinforced plastic member M is improved as long as the second reinforced fiber layer group 2 is arranged in the tensile side region TR. However, the hardness of the fiber reinforced plastic member M can be improved most effectively by arranging the second reinforced fiber layer group 2 in the outermost layer.

In the present embodiment, only a single second reinforced fiber layer group 2 is arranged in the compressive side region CR. Although a single second reinforced fiber layer group 2 is preferable to suppress the number of stacked layers, this does not prevent two or more second reinforced fiber layer groups 2 from being arranged in the compressive side region CR. For example, the following structure may be used: The second reinforced fiber layer group 2 that is a first group is arranged in the outermost layer of the compressive side region CR, and the first reinforced fiber layer 1 is arranged in the adjacent inner side thereof. The second reinforced fiber layer group 2 that is a second group is then arranged in the inner side of this first reinforced fiber layer 1. The first reinforced fiber layers 1 are then arranged in the inner side of the second reinforced fiber layer group 2 that is a second group and in the remaining reinforced fiber layers of the tensile side region TR.

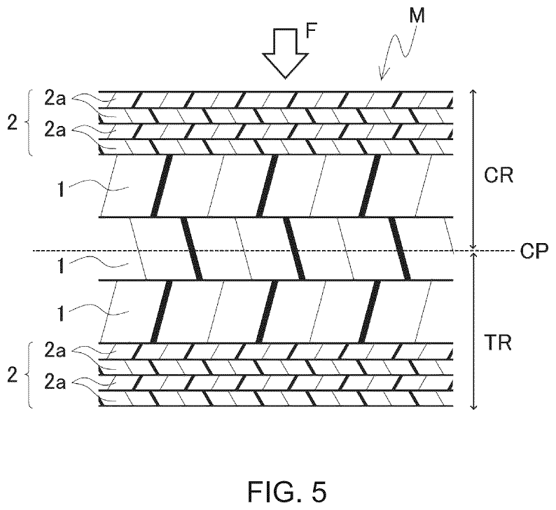

FIG. 5 illustrates a fiber reinforced plastic member M of the third embodiment. In the present embodiment, the second reinforced fiber layer group 2 is arranged in the tensile side region TR and the compressive side region CR, respectively. This configuration makes it possible to improve a bending elastic modulus (hardness) of the fiber reinforced plastic member M compared with the case in which the second reinforced fiber layer group 2 is arranged only in the compressive side region CR as in the second embodiment. However, the bending strength of the fiber reinforced plastic member M is inferior to the case in which the second reinforced fiber layer group 2 is arranged only in the tensile side region TR as in the first embodiment, but is improved compared with the case in which the second reinforced fiber layer group 2 is arranged only in the compressive side region CR as in the second embodiment. The reason why the bending strength of the fiber reinforced plastic member M in the present embodiment is lower than that in the first embodiment is that layer separation tends to occur in the second reinforced fiber layers 2a of the second reinforced fiber layer group 2 in the compressive side region CR due to compression fracture.

Therefore, the arrangement of the second reinforced fiber layer group 2 as in the present embodiment may be effective depending on the mechanical characteristics (strength and elastic modulus) required at the position of the vehicle body where the fiber reinforced plastic member M is used. In the present embodiment, although the second reinforced fiber layer group 2 is arranged in the tensile side region TR and the compressive side region CR, respectively, however, this does not prevent the second reinforced fiber layer group 2 from being further arranged in addition to these two second reinforced fiber layer groups 2.

In particular, in the present embodiment, the second reinforced fiber layer group 2 is used as the outermost layer in the tensile side region TR of the fiber reinforced plastic member M, and as the outermost layer in the compressive side region CR of the fiber reinforced plastic member M. Therefore, an elastic modulus (hardness) of the fiber reinforced plastic member M can be improved most effectively by the second reinforced fiber layer group 2, and the strength thereof can also be improved to some extent, thereby improving the mechanical strength of the fiber reinforced plastic member M in a balanced manner.

In the first to third embodiments described above, the second reinforced fiber layer 2a has a thickness of preferably 80 μm or more and 300 μm or less. In the second reinforced fiber layer 2a formed by using the tow, which is spread, the filaments are spread thinly, thereby improving the mechanical properties as described above. If the thickness is less than 80 μm, the thickness of the tow which is spread is too thin and the straightness of the tow is reduced, and thus gaps between the reinforced fibers are likely to be generated at the time of stacking. If such gaps are likely to be generated, it will be difficult to obtain the effect of improving the mechanical properties acquired by improving a fiber volume content rate Vf. In addition, if the thickness is less than 80 μm, it will be difficult to obtain the effect of improving the productivity because the number of stacked layers of the second reinforced fiber layers 2a increases. Meanwhile, if the thickness exceeds 300 μm, it will be difficult to obtain the above-described effect which is brought by thinning the layers due to “tow spreading”.

In the first to third embodiments described above, the reinforced fibers of the second reinforced fiber layer 2a are preferably carbon fibers. Since carbon fibers have a light weight among the reinforced fibers, they can effectively contribute to the weight reduction of the vehicle body. Further, carbon fibers have excellent fatigue resistance, chemical resistance, and corrosion resistance among the reinforced fibers, and are suitable for use in the vehicle body. Furthermore, carbon fibers have excellent strength, and are easily applicable to the tow spreading technology.

The present invention is not limited to the embodiments described above. For example, FIG. 2 illustrates the case in which the external force F to bend the fiber reinforced plastic member 100 acts in the thickness direction of the fiber reinforced plastic member 100, that is, in the stacking direction of the reinforced fiber layers 101. However, the direction of the external force F to bend the fiber reinforced plastic member M is not limited to the thickness direction or stacking direction. In some cases, the fiber reinforced plastic member Mis bent by the external force F from a direction other than the thickness direction or stacking direction. Even in such cases, the “tensile side region TR” and “compressive side region CR” can be defined by considering the bending shape of the fiber reinforced plastic member M (bending outer side or inner side).

In the above embodiments, the reinforced fibers of the first reinforced fiber layer 1 and the second reinforced fiber layer 2a are carbon fibers. As described above, the reinforced fibers of the second reinforced fiber layer 2a is preferably carbon fibers; however, the reinforced fibers of the first reinforced fiber layer 1 and the second reinforced fiber layer 2a are not limited to carbon fibers. Other reinforced fibers such as glass fibers, aramid fibers, boron fibers, Kevlar fibers, and natural fibers may be used. In addition, the type of matrix resin used for the fiber reinforced plastic member M is not limited, and for example, a thermosetting resin or a thermoplastic resin may be used as described above. Further, a molding method of the fiber reinforced plastic member M is not limited, and various molding methods using reinforced fibers that are long fibers, such as autoclave molding using prepreg and RTM method, can be used.

1. A fiber reinforced plastic member which is a fiber reinforced plastic member for a vehicle body, the fiber reinforced plastic member comprising:
a plurality of first reinforced fiber layers formed by reinforced fiber bundles which are not spread;
a second reinforced fiber layer group in which a plurality of second reinforced fiber layers formed by reinforced fiber bundles which are spread are continuously stacked; and
a matrix resin which is impregnated into the plurality of first reinforced fiber layers and the plurality of second reinforced fiber layers and is reinforced by the plurality of first reinforced fiber layers and the plurality of second reinforced fiber layers, wherein
when a load is generated in an in-plane direction by an external force bending the fiber reinforced plastic member and a compressive force or a tensile force acts on the fiber reinforced plastic member, in a case where a region of a bending inner side of the fiber reinforced plastic member is defined as a compressive side region on which a compressive stress acts and a region of a bending outer side of the fiber reinforced plastic member is defined as a tensile side region on which a tensile stress acts with respect to a center plane having a thickness of the fiber reinforced plastic member, the second reinforced fiber layer group is arranged only in the tensile side region.

2. A fiber reinforced plastic member which is a fiber reinforced plastic member for a vehicle body. the fiber reinforced plastic member comprising:
a plurality of first reinforced fiber layers formed by reinforced fiber bundles which are not spread;
a second reinforced fiber layer group in which a plurality of second reinforced fiber layers formed by reinforced fiber bundles which are spread are continuously stacked; and
a matrix resin which is impregnated into the plurality of first reinforced fiber layers and the plurality of second reinforced fiber layers and is reinforced by the plurality of first reinforced fiber layers and the plurality of second reinforced fiber layers, wherein
when a load is generated in an in-plane direction by an external force bending the fiber reinforced plastic member and a compressive force or a tensile force acts on the fiber reinforced plastic member, in a case where a region of a bending inner side of the fiber reinforced plastic member is defined as a compressive side region on which a compressive stress acts and a region of a bending outer side of the fiber reinforced plastic member is defined as a tensile side region on which a tensile stress acts with respect to a center plane having a thickness of the fiber reinforced plastic member, the second reinforced fiber layer group is arranged only in the compressive side region.

3. The fiber reinforced plastic member according to claim 1, wherein
the second reinforced fiber layer group is an outer most layer of the fiber reinforced plastic member.

4. The fiber reinforced plastic member according to claim 1, wherein
each of the plurality of second reinforced fiber layers has a thickness of 80 μm or more and 300 μm or less.

5. The fiber reinforced plastic member according to claim 1, wherein
reinforced fibers of the reinforced fiber bundles used for the plurality of second reinforced fiber layers are carbon fibers.

6. A fiber reinforced plastic member which is a fiber reinforced plastic member for a vehicle body, the fiber reinforced plastic member comprising:
a plurality of first reinforced fiber layers formed by reinforced fiber bundles which are not spread;
a second reinforced fiber layer group in which a plurality of second reinforced fiber layers formed by reinforced fiber bundles which are spread are continuously stacked; and
a matrix resin which is impregnated into the plurality of first reinforced fiber layers and the plurality of second reinforced fiber layers and is reinforced by the plurality of first reinforced fiber layers and the plurality of second reinforced fiber layers, wherein the second reinforced fiber layer group is arranged on a vehicle interior side with respect to a center plane having a thickness of the fiber reinforced plastic member.

7. The vehicle body panel member according to claim 6, wherein
the second reinforced fiber layer group is an outer most layer of the fiber reinforced plastic member.

8. The vehicle body panel member according to claim 6, wherein each of the plurality of second reinforced fiber layers has a thickness of 80 μm or more and 300 μm or less.

9. The vehicle body panel member according to claim 6, wherein reinforced fibers of the reinforced fiber bundles used for the plurality of second reinforced fiber layers are carbon fibers.

10. A vehicle body panel member composed of a fiber reinforced plastic member, the fiber reinforced plastic member comprising:
a plurality of first reinforced fiber layers formed by reinforced fiber bundles which are not spread;
a second reinforced fiber layer group in which a plurality of second reinforced fiber layers formed by reinforced fiber bundles which are spread are continuously stacked; and
a matrix resin which is impregnated into the plurality of first reinforced fiber layers and the plurality of second reinforced fiber layers and is reinforced by the plurality of first reinforced fiber layers and the plurality of second reinforced fiber layers, wherein
the second reinforced fiber layer group is arranged on an outer surface side of a vehicle body with respect to a center plane having a thickness of the fiber reinforced plastic member.

11. The vehicle body panel member according to claim 10, wherein
the second reinforced fiber layer group is an outer most layer of the fiber reinforced plastic member.

12. The vehicle body panel member according to claim 10, wherein
each of the plurality of second reinforced fiber layers has a thickness of 80 μm or more and 300 μm or less.

13. The vehicle body panel member according to claim 10, wherein
reinforced fibers of the reinforced fiber bundles used for the plurality of second reinforced fiber layers are carbon fibers.
